(19) United States
(12) Patent Application Publication
(10) Pub. No.: US 2008/0195824 A1
(43) Pub. Date: Aug. 14, 2008

(54) CONTEXT SENSITIVE CACHING ON REMOVABLE STORAGE

(75) Inventors: Vladimir Sadovsky, Redmond, WA (US); Robin A. Alexander, Redmond, WA (US); Blake D. Manders, Seattle, WA (US)

Correspondence Address: Intellectual Property Department;Amylin Pharmaceuticals, Inc., 9360 Towne Centre Drive, San Diego, CA, 92121, US

(73) Assignee: Microsoft Corporation, Redmond, WA (US)

(21) Appl. No.: 11/673,489

(22) Filed: Feb. 9, 2007

(51) Int. Cl. G06F 12/00

(52) U.S. Cl. 711/158; 711/E12.091

(57) ABSTRACT

A method and apparatus is described for receiving and storing data from a first host device and performing actions or events on a second host device based on the stored data. Also, a priority factor value may be determined for the stored data such that actions or events performed on the second host device may be based on the priorities of the stored data. For example, a removable, portable device may be connected to the first or the second host device. The stored data is accessed by the second host device and the stored data and the action or event on the second host device is performed based on the stored data. In another example, the stored data is not stored on the second host device. Thus, the stored data may be secure and trusted.

### BACKGROUND

Removable storage devices have become increasingly popular. Users may transfer data from one computing device to another computing device by connecting portable storage devices to one computing device and storing information from the computing device onto the portable storage device. The portable storage device may then be connected to a second computing device and this information may be transferred to the second computing device.

However, sensitive or otherwise private information may be stored on a removable storage device and, if connected to the second computing device, the information transferred to the second computing device may cause a breach in security. For example, data from a corporate computer in a corporate network may be transferred or downloaded to a removable storage device. The removable storage device may then be disconnected from the corporate computer and may be connected to a publicly used computer in a café. In this case, sensitive or confidential information from the corporate computer may be left on the publicly used computer. This may result in security problems for the computer user.

In addition, some information may be more relevant for use on a host device than other information. Typically, activities or events performed on a host device do not have knowledge of relevance of remote data. Thus, a typical host device may have difficulty in performing activities or events efficiently. Thus, a system or method is needed for enhanced efficiency in providing cache data or other information in a computing environment and for selective targeting of cached information.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

In one example, a method is described in which data may be received at a portable, removable storage device from a first host device. The data may be stored in memory of the storage device and may further be used to perform an action or event on a second host device. In another example, a priority factor value may be determined for the stored data. The action or event on the second host device may further be performed based on the priority factor values.

In another example, the data from the first host device includes cache data. The cache data may include web cache data, user profiles, user preferences, applications, or any other relevant data for performing actions or events on a second host device.

In another example, a roaming cache device is described including a caching module, a prioritizer for determining a priority factor value for data received in the caching module, a memory for storing the received data and corresponding priority factor values, and an access module for providing access to the data for a host device.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 illustrates an example of a suitable computing system environment 100 on which a method of storing and/or prioritizing data may be implemented.

FIG. 2 illustrates an example of a roaming cache device.

FIG. 3 illustrates another example of a roaming cache device.

FIG. 4 illustrates an example of memory in a roaming cache device.

FIG. 5 is a flowchart illustrating one example of caching data on a removable device.

FIG. 6 is a flowchart illustrating an example of a roaming cache device and a consuming host device.

FIG. 7 is a flowchart illustrating one example of determining priority of cache information on a roaming cache device.

FIG. 8 is a flowchart illustrating examples of priority value determination of cache information.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

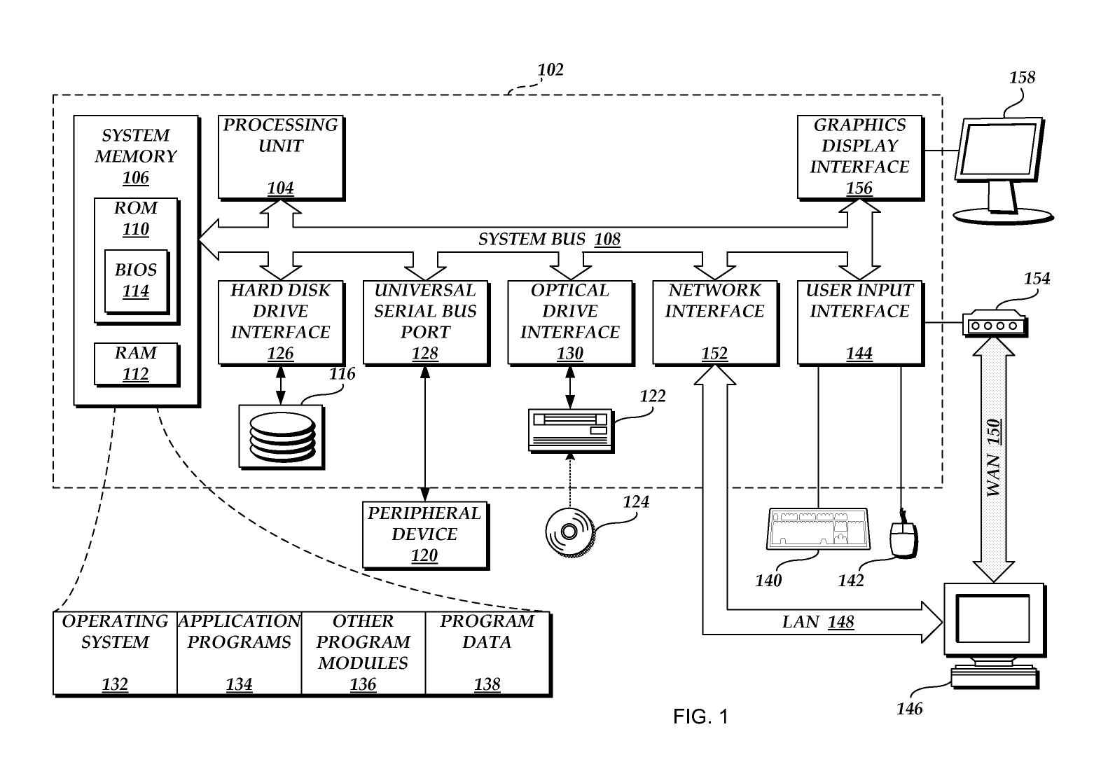

FIG. 1 illustrates an example of a suitable computing system environment on which a method of context sensitive caching may be implemented. The computing system environment is only one example of a suitable computing environment and is not intended to suggest any limitation as to the scope of use or functionality of the invention. Neither should the computing environment be interpreted as having any dependency or requirement relating to any one or combination of components illustrated in the exemplary operating environment.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a general purpose computing device in the form of a computer 102. Components of computer 102 may include, but are not limited to, a processing unit 104, a system memory 106, and a system bus 108 that couples various system components including the system memory to the processing unit 104. The system bus 108 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 102 typically includes a variety of computer readable media. Computer readable media can be any available media that can be accessed by computer 102 and includes both volatile and nonvolatile media, removable and non-removable media. By way of example, and not limitation, computer readable media may comprise computer storage media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 102. In addition, computer storage media may include a removable storage device. The removable storage device may be connected to the computer and may receive data from the computer. The data received from the computer may be stored on the removable storage device which may be disconnected from the computer. The removable storage device may be used to transfer data from one computer or computer system to another. In one example, the removable storage device may include a USB flash disk, however, any removable storage device may be used such as a Secure Digital (SD) memory device, mini SD memory device, XD memory device, memory stick, etc. Combinations of the any of the above should also be included within the scope of computer readable storage media.

The system memory 106 includes computer storage media in the form of volatile and/or nonvolatile memory such as read only memory (ROM) 110 and random access memory (RAM) 112. A basic input/output system 114 (BIOS), containing the basic routines that help to transfer information between elements within computer 102, such as during start-up, is typically stored in ROM 110. RAM 112 typically contains data and/or program modules that are immediately accessible to and/or presently being operated on by processing unit 104. By way of example, and not limitation, FIG. 1 illustrates operating system 132, application programs 134, other program modules 136, and program data 138.

The computer 102 may also include other removable/non-removable, volatile/nonvolatile computer storage media. By way of example only, FIG. 1 illustrates a hard disk drive 116 that reads from or writes to non-removable, nonvolatile magnetic media and an optical disk drive 122 that reads from or writes to a removable, nonvolatile optical disk 124 such as a CD ROM or other optical media. These are merely examples of removable/non-removable, volatile/nonvolatile computer storage media. For example, the computer 102 may also include a magnetic disk drive (not shown) that reads from or writes to a removable, nonvolatile magnetic disk (not shown). Additionally or alternatively, other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 116 is typically connected to the system bus 108 through a non-removable memory interface such as interface 126 and optical disk drive 122 may be connected to the system bus 108 by a removable memory interface, such as interface 130. Additionally or alternatively, a magnetic disk drive may be connected to the system bus 108 by a removable memory interface such as a magnetic drive interface (not shown).

In addition, the computer 102 may contain a Universal Serial Bus (USB) port 128 through which a peripheral device 120 may be connected. In one example, a portable storage device may be connected to the computer 102 via the USB port 128. The portable storage device may be any portable device that may be removable from the computer 102 and may be connected to another computer or computer system. Data from one computer may be transferred to another computer via the portable storage device (e.g., peripheral device 120). One example of a portable storage device may include a flash disk.

The drives and their associated computer storage media discussed above and illustrated in FIG. 1, provide storage of computer readable instructions, data structures, program modules and other data for the computer 102. Alternatively or additionally, computer storage devices may be portable storage devices that may store data. For example, the computer 102 may contain data stored in system memory 106. The stored data may be transferred via system bus 108 to the peripheral device 120 via the USB port 128. In this example, the peripheral device 120 includes a portable storage device that may be connected or disconnected from the computer 102. For example, the portable storage device (e.g., peripheral device 120) may be connected to the USB port 128 of computer 102. Data stored in the system memory 106 is transferred via the system bus 108 to the USB port 128. The data is further transferred via the USB port 128 to the portable storage device and stored therein. The portable storage device (e.g., peripheral device 120) may be disconnected or removed from computer 102. Additionally, the portable storage device (e.g., peripheral device 120) may be reconnected to another computer or computer system. Data may thus be transferred between different computers or computer systems via the portable storage device (e.g., peripheral device 120).

In FIG. 1, for example, hard disk drive 116 is illustrated as storing operating system 132, application programs 134, other program modules 136, and program data 138. Note that these components can either be the same as or different from additional operating systems, application programs, other program modules, and program data, for example, different copies of any of the elements. A user may enter commands and information into the computer through input devices such as a keyboard 140 and pointing device 142, commonly referred to as a mouse, trackball or touch pad. Other input devices (not shown) may include a microphone, joystick, game pad, satellite dish, scanner, or the like. These and other input devices are often connected to the processing unit 104 through a user input interface 144 that is coupled to the system bus, but may be connected by other interface and bus structures, such as a parallel port, game port or a universal serial bus (USB). A monitor 158 or other type of display device is also connected to the system bus 108 via an interface, such as a video interface or graphics display interface 156. In addition to the monitor 158, computers may also include other peripheral output devices such as speakers (not shown) and printer (not shown), which may be connected through an output peripheral interface (not shown).

The computer 102 may operate in a networked environment using logical connections to one or more remote computers, such as a remote computer. The remote computer may be a personal computer, a server, a router, a network PC, a peer device or other common network node, and typically includes many or all of the elements described above relative to the computer 102. The logical connections depicted in FIG. 1 include a local area network (LAN) 148 and a wide area network (WAN) 150, but may also include other networks. Such networking environments are commonplace in offices, enterprise-wide computer networks, intranets and the Internet.

When used in a LAN networking environment, the computer 102 is connected to the LAN 148 through a network interface or adapter 152. When used in a WAN networking environment, the computer 102 typically includes a modem 154 or other means for establishing communications over the WAN 150, such as the Internet. The modem 154, which may be internal or external, may be connected to the system bus 108 via the user input interface 144, or other appropriate mechanism. In a networked environment, program modules depicted relative to the computer 102, or portions thereof, may be stored in the remote memory storage device. By way of example, and not limitation, remote application programs may reside on a memory device. It will be appreciated that the network connections shown are exemplary and other means of establishing a communications link between the computers may be used.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

In another example, a computer-readable medium having computer-executable instructions stored thereon is provided in which execution of the computer-executable instructions performs a method as described herein. The computer-readable medium may be included in a system or computer and may include, for example, a hard disk, a magnetic disk, an optical disk, a CD-ROM, etc. A computer-readable medium may also include any type of computer-readable storage media that can store data that is accessible by computer such as random access memories (RAMs), read only memories (ROMs), and the like.

A method and system is described for storing data from a host device on a portable or removable roaming cache device and utilizing the stored data on the roaming cache device on a second host device for enhanced performance on the second host device. The data may further be assigned a priority value and may be automatically ranked and/or stored based on the priority value. The data may be cached on the roaming cache device for use on multiple host device such as computing devices or personal computers. The stored data on the roaming cache device may further include priority values associated with other stored data on the roaming cache device. A user may roam between different computing devices and may access data on any of the different computing devices. Access of such data may be based on the data cached and/or prioritized on the roaming cache device.

For example, a user may connect the roaming cache device to a first computing device. The first host device may be a producing host device that contains user information such as web cache data, user preferences, profiles, policies, permissions, etc. and may access networks or the internet on the user's behalf. Information from the first computing device (i.e., producing host device) may be copied, downloaded, and/or stored into memory on the roaming cache device from the first computing device. The information may include any desired information such as executable files, controls, web content, cookies, user preferences, permissions, user profile information, mail information, audio/video data, etc. Any data may be transferred to the roaming cache device. In addition, some or all of this data may be protected by the roaming device from unauthorized access.

The roaming cache device may further be connected to a second host device such as a remote computing device. The second host device may be any device capable of connecting to the roaming cache device. For example, the second host device may be a computing device, an electronic device, a television, an automobile, etc. The second host device may be a consuming host device that does not contain user information. One example of a consuming host is a publicly used computer such as a computer in an Internet café. Such a publicly used computer may not contain user preferences, policies, etc. associated with a specific user. Also, a user may not wish to leave any trace of user information on the second host device. For example, the user may be using a publicly used computer and may wish not to leave traces of activity on the publicly used computer after completing use of the computer.

The user may disconnect the roaming cache device from the first computing device (producing host) in this example and connect the roaming cache device to a second computing device (consuming host). The second computing device (consuming host) may be, for example, a publicly shared computing device that may not contain information on the user. The user connects the roaming cache device to the second computing device and information stored in the roaming cache device may be used to perform actions on the second computing device. As one example, the information stored in the roaming cache device may include simple web cache data such that the user may connect the roaming cache device to the second computing device and browse the internet on the second computing device. Accessing or downloading web data in this example may be based on the web cache data stored in the roaming cache device. Thus, desired data may be obtained on the second computing device in an efficient manner based on the web cache data in the roaming cache device.

Also, the stored data on the roaming cache device may be ranked or prioritized. The stored data may include multiple portions that may be stored in the roaming cache device with an associated priority factor. After connection of the roaming cache device to the second host device, actions may be performed on the second host device according to the priorities of the data stored on the roaming cache device.

In another example, the stored data in the roaming cache device may include data from multiple sources. Each of the sources may be located on one or multiple host devices and copied and/or downloaded from the one or multiple host devices to the roaming cache device. For example, e-mail information, cookies, schedule, calendar, preferences, or any other desired information may be obtained from one or more sources of information on one or more host devices (e.g., personal computers) and stored on the roaming cache. The information may further be prioritized based on any number of factors. Such factors may include, for example, frequency of prior use, location, user profiles, past history, preferences, etc. The information may further be output to another host device (e.g., a remote computer).

Also, the roaming cache device may provide stored data to the second host device or consuming host. The information may be prioritized such that the consuming host may perform an action or event based on the prioritization of the data stored on the roaming cache device. For example, certain information may have a high priority and may be stored on the roaming cache device in a manner to indicate the high priority of the information. Other information may have a low priority and may be stored on the roaming cache device in a manner to indicate the low priority of the information. The second host device or consuming host may access the prioritized information stored on the roaming cache device and may provide information corresponding to the high priority stored on the roaming cache device. Likewise, the second host device or consuming host may also provide information corresponding to the low priority information stored on the roaming cache device but in a lower priority position. Thus, information may be presented or provided on the second host device that may vary based on corresponding priority information from the roaming cache device.

In this example, the consuming host may be a device such as a personal computer on which the user may wish not to leave personal information. One example of such a device may be a publicly shared computer in which the user may wish not to leave personal information for a subsequent user. In this case, the consuming host may access the prioritized information stored on the roaming cache device but may not substantially store the prioritized data itself. For example, after the event or action is performed on the consuming host (e.g., based on the prioritized information stored on the roaming cache device), the roaming cache device may be disconnected from the consuming host. After disconnection of the roaming cache device, the consuming host may not contain or store any information of the actions or events performed pertaining to the roaming cache device or the prioritized information stored on the roaming cache device.

In another example, the roaming cache device may provide the prioritized information for the consuming host to perform an action or event. The action or event may be performed on the consuming host that accesses the prioritized information stored on the roaming cache device. After the event or action is performed, the roaming cache device may receive input from the consuming host indicating that no prioritized information or data from the roaming cache device is stored on the consuming host. Hence, the consuming host may remove traces of related activity or may not store the prioritized information locally (i.e., on the consuming host). Thus, the roaming cache device may be disconnected from the consuming host and the user may know that no personal information has been left on the consuming host device.

In another example, the roaming cache device may connect to the second host device or consuming host device. The roaming cache device may further determine an authentication status of the second host device or consuming host device. Also, the roaming cache device may authenticate another host device or consuming host connected to the network of the second host device. The roaming cache device may provide the prioritized information to a host device in the network other than the second host device (e.g., the other host device authenticated by the roaming cache device). The prioritized information may be provided to the authenticated host device via the second host device.

In this example, the second host device may be determined to be an untrusted host device in the network. Therefore, the roaming cache device may determine that sharing the prioritized information with the second host device may be undesired. The roaming cache device may further identify another host device in the network that is trusted. For example, the roaming cache device may authenticate a different host device in the network via the connection with the second host device. For example, the roaming cache device may poll host devices in the network by transmitted a query via the connection with the second host device. The query may be transmitted via the second host device to other host devices connected to the network. Other host devices may respond to the query and may return identification information to the roaming cache device via the second host device.

In this example, other host devices in the network may transmit corresponding identification and/or location information over the network to the second host device. The identification information may be transmitted through the second host device to the roaming cache device that is connected to the second host device. Based on the received identification and/or location information, the roaming cache device may identify a trusted host device via the authentication process. The roaming cache device may provide the prioritized information stored within the roaming cache device to authenticated or trusted host devices through the connection with the second host device. For example, authenticated or trusted host devices may access the prioritized information on the roaming cache device (i.e., roaming cache device permits access of the prioritized information for trusted host devices). Also in this example, the roaming cache device may block access to the prioritized information from the second host device if the second host device is determined to be untrusted or unauthenticated (i.e., fails an authentication process).

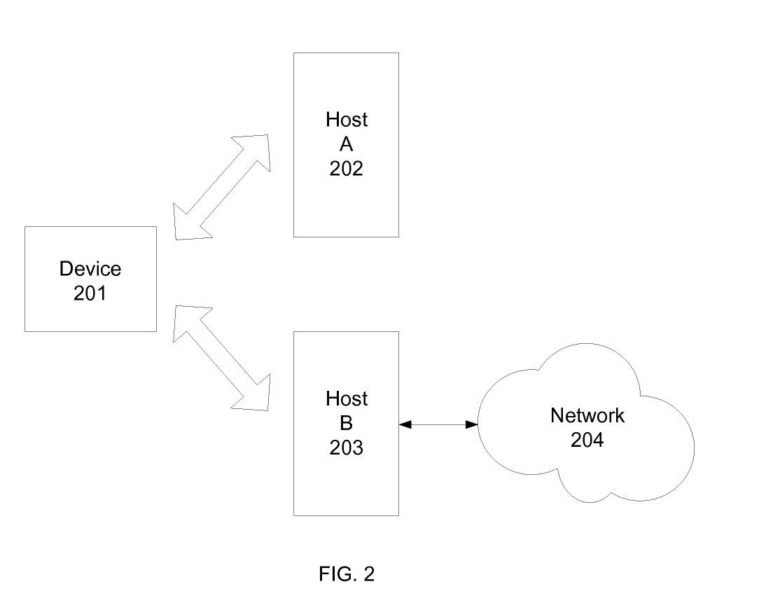

FIG. 2 illustrates one example of a device such as a roaming cache device 201. In this example, a roaming cache device 201 may connect with a first host such as Host A 202 or a second host such as Host B 203. Host B 203 may further be connected to a network 204. In addition, host A 202 may also be connected with network 204 (not shown).

A user may roam between different devices. In the example illustrated in FIG. 2, a user may roam between host A 202 and host B 203. Also, information may be transferred from a host device such as host A 202 to the roaming cache device 201 for use on another host device such as host B 203. For example, a user may connect the roaming cache device 201 to host A 202 and information such as cache information may be transferred from host A 202 to the roaming cache device 201 and stored thereon. The roaming cache device 201 may be disconnected from host A 202 and may be connected to host B 203. Actions and events may be performed on host B 203 based on the information (e.g., cache information) stored in memory on the roaming cache device 201. Also, data, such as accumulated information on user preferences and priorities, may be uploaded from the roaming cache device into a “master” host device (e.g., a home computer) and synchronized with a permanent user profile after user roams between hosts.

The connection between roaming cache device 201 with host A 202 may be accomplished by a variety of methods. For example, roaming cache device 201 may connect to host A 202 via a USB connection, short range wireless connection (e.g., wireless USB), or any other suitable connection. While connected to host A 202, roaming cache device 201 may receive any data such as cache information from host A 202 and may further store the received data in memory.

The data received and stored by the roaming cache device 201 may include any relevant or desired information. Also, the information transferred from host A 202 to the roaming cache device 201 may be prioritized, ranked, or protected in the roaming cache device 201. Alternatively, the information may be prioritized, ranked, or protected on the host device such as host A 202 and transferred or downloaded to the roaming cache device 201. In one example, information may be received from different data sources in host A 202. Each of the information from the different data sources may be assigned a priority factor value corresponding to importance or relevance of the data. The data may be stored in the roaming cache device 201 according to the corresponding priorities.

In one example, the data may include personal or portable web cache information. The personal/portable web cache information may be located on host A 202 (e.g., a personal computer) and may expedite display of associated images and/or content on a second device such as host B 203. As web sites are visited by the user on host A 202, web cache information corresponding to the visited websites may be stored on host A 202. If the user visits certain websites regularly or frequently, the corresponding web cache information may be transferred to the roaming cache device 201. Alternatively or additionally, web content information predicted to be of interest to a user may be stored on the roaming cache device 201. After connection of the roaming cache device to host B 203, loading or display of websites on host B 203 may be based on the stored web cache information which includes in this example web cache information corresponding to the previously visited websites. The user may access, download or display website content or information on host B 203 based on the web cache information in the roaming cache device 201. In one example, the web cache information is not stored on host B 203 but is accessed by host B 203 on the roaming cache device 201.

The personal or portable web cache information may further include past history information of the user. For example, a user may have visited a particular website a predetermined number of times or may have downloaded particular content from a website a certain number of times or at a certain frequency. Based on a history of prior actions of the user, personal or portable web cache information may be collected and/or generated and may further be stored on host A 202 or, alternatively or additionally, on roaming cache device 201. The information generated or stored at host A 202 may further be transferred to the roaming cache device 201. For example, a user may download or copy the information from host A 202 to device 201 or the information may be transferred automatically.

In this example, a pattern of prior use by the user may be stored on the roaming cache device 201. When roaming cache device 201 is connected to host B 203, an action or event may be performed on host B 203 based on the past history information of the user. For example, if a user visits a particular website a number of times that is greater than a predetermined number or if the user visits the particular website at a frequency over a period of time that is greater than a predetermined frequency, web cache information corresponding to the website may be included in data downloaded or transferred to the roaming cache device 201.

In one example, privacy of a user may be protected. For example, specific history information corresponding to the user may not be made available to an untrusted host. In another example, an interface host may obtain hints to further optimize and personalize a user browsing experience. In this case, a processor on the roaming cache device will perform processing of stored private data and provide specific responses.

In another example, user preferences or permissions may also be stored on the roaming cache device 201. This information may be input by the user or may be provided via other means including, but not limited to, hard-coded in the roaming cache device 201 by a manufacturer, polling of devices by host A 202, application data from applications running on host A 202 or other host devices in communication with host A 202, etc. Any of this information may be downloaded and stored on the roaming cache device 201, which may be connected to a second host device (e.g., host B 203). After connection to the second host device, events may be performed on the second host device based on the information stored on the roaming cache device 201. For example, a user may access websites on the second host device (e.g., host B 203) based on the stored information on the roaming cache device 201 such that access to the websites may be expedited by access to corresponding web cache information on the roaming cache device. Alternatively, a user may search for desired information on host B 203 and search results may be based on the data stored on the roaming cache device 201. Additionally or alternatively, additional accumulated information may be written by the host to the roaming cache device to further update user profile information.

Also, host B 203 may be connected to a server device. The roaming cache device may be connected to host B 203 and may further connect to the server device via host B 203. User identity and/or priorities may be verified, authenticated, or updated from the server via host B 203. For example, the roaming cache device 201 may authenticate host B 203 to ensure that host B 203 may have access to data stored on roaming cache device 201. In one example, the roaming cache device 201 may receive an identifier that identifies an identity of host B 203 and/or the server device connected to host B 203. Based on the identity of host devices, the roaming cache device 201 may authenticate a host device. If, for example, host B 203 is not authenticated, roaming cache device 201 may receive no trust information from host B 203. Roaming cache device 201 may thus form a pass through (or tunnel) connection with the server device. In this example, the server device (e.g., internet rights server) may validate a user identity and/or update priorities via a pass through or tunnel connection with the roaming cache device 201 through host B 203

One additional claim I want to stress is when firmware of roaming device directly connects to the internet rights server across untrusted second host to validate user identity and update priorities. This is called pass through (or tunnel) connection and is very important flavor of the invention.

In another example, geographically relevant data and information may be collected and placed by a producing host onto a roaming cache device. The geographically relevant data may be selected based on a variety of factors. For example, the geographically relevant data may be selected by the producing host based on an itinerary or travel plans of the user. In one example, travel plans or itinerary information may be obtained from a mail application (e.g., e-mail). Based on the travel plan or itinerary information, the producing host may provide data relevant to the itinerary.

These are merely examples of data that may be stored on a roaming cache and are not intended to be limiting as any type of pertinent information may be stored. For example, the data stored on the roaming cache device 201 may include remotely secured functional caching information such as applications, controls, communication software such as mail software or instant messaging software. Alternatively or additionally, the data may include any type of predictive caching information such as, but not limited to, serialized content, synchronous content media content, proximate content or special logic. In addition, the data may also include trustworthy cache information such as trusted controls as one example.

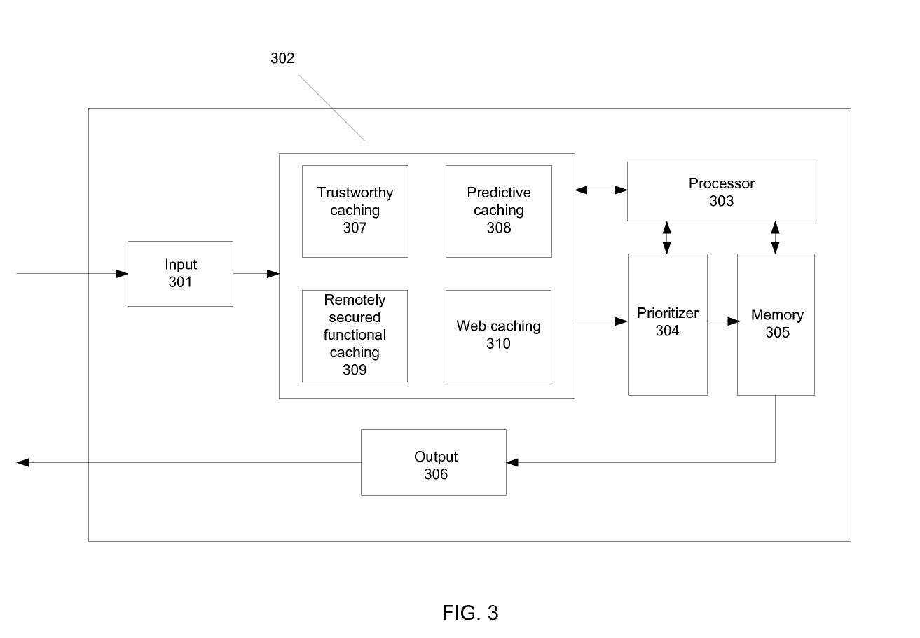

FIG. 3 illustrates an example of a roaming cache device. As FIG. 3 illustrates, a roaming cache device may include an input 301, a caching module 302, a processor 303, a prioritizer 304, a memory 305 and/or an access module 306. In addition, caching module 302 may include any number of modules for processing, receiving, and/or selecting data such as a trustworthy caching module 307, a predictive caching module 308, a remotely secured functional caching module 309, and/or a web caching module 310. The illustration of FIG. 3 is merely one example and any additional components may be included in a roaming cache device. In addition, any of the components illustrated in FIG. 3 may be re-configured, rearranged, combined or skipped.

In the example of FIG. 3, the input 301 may receive data from a host device (not shown). For example, the roaming cache device may be connected to a personal computer (i.e., producing host device). Data from the personal computer may be downloaded or transferred to the roaming cache device and received at the roaming cache device via the input 301. This information received at the roaming cache device may include any pertinent information and may further include user information. The data received via input 301 may be stored in memory 305 and may further be identified as to type of data and/or relative significance. For example, data received via input 301 may be identified in a caching module 302. A processor 303 may control the identification of data received at the roaming cache device from a host device.

In one example, a trustworthy caching module 307 may be used to validate or pre-validated data of known origin or creation. This information may include trusted information including, for example, controls or executables. One example may include ActiveX controls. Thus, in this example, an ActiveX control may be received from a host computing device via input 301. The ActiveX control may further be identified by the trustworthy caching module 307 and stored in memory 305 on the roaming cache device. The ActiveX control may subsequently be installed and/or executed on a second host computing device. In one example, the second host computing device itself is not trustworthy, however, the ActiveX control on the roaming cache device is determined to be trustworthy on a trustworthy roaming cache device. A user need not accept installation of the control to grant a web application control over a host application, for example. Instead, the control may be stored on a trusted roaming cache device and executed on a host device from the roaming cache device when desired.

In another example, a predictive caching module 308 may receive and process data via input 301 and may further generate a predictive model for content expected to be requested or desired at a subsequent time. For example, the roaming cache device may be connected to a host device such as a personal computing device. The personal computing device may contain user information. The user information may include, for example, information indicating preferences of the user or past history of activity of the user. The information may be transferred or downloaded to the roaming cache device and received at the predictive caching module 308. Based on the information, the predictive caching module 308 may determine content expected to be requested or desired and may pre-cache content based on the determination. The content expected to be requested or desired may be downloaded and stored on the roaming cache device.

In one example, the information may be prioritized or ranked on a producing host. The roaming cache device is connected to the producing host and the prioritized or ranked information may be transferred from the producing host to the roaming cache device and stored therein. After storing the prioritized and ranked data received from the producing host, the roaming cache device may be disconnected from the producing host and may be subsequently connected to a consuming host. The consuming host may be operated by the user based on the prioritized or ranked data stored on the roaming cache device. For example, the roaming cache device may store the information from the producing host in a configuration corresponding to the priorities assigned to the information at the producing host. The consuming host, after the roaming cache device is connected, may execute based on the configuration of the stored prioritized information on the roaming cache device.

As one example of pre-caching information in the roaming cache device, serialized content may be obtained and pre-cached in the device. Serialized content may include any data that is accessed and, in particular, data for which updates may be additive. In this example, subsequent caching of the data may include downloading additional data since the prior download. Hence, previously downloaded data may remain in memory while only additional data corresponding to the original content is downloaded. In yet another example, the predictive caching module 308 may obtain and pre-cache synchronized content which may include information that has been explicitly subscribed to.

In another example, rich media content may be received at the predictive caching module 308 via input 301. Rich media content may include any media content such as, but not limited to, video and/or audio data. For example, a user may frequently consume certain media content in the past. Information describing media consumption habits of the user or media content itself may be downloaded to the roaming cache device via input 301 and received at the predictive caching module 308. Based on previously downloaded and/or viewed media data or a frequency of usage of the media data, videos or other media data may be pre-emptively downloaded. Thus, the predictive caching module 308 may identify additional rich media content for caching based on received user information. In another example, the user information may include past consumption trends and/or content metadata. Alternatively or additionally, the user information may include other content methods such as a “video of the day” as shown on a Live homepage.

Also, the predictive caching module 308 may manage licenses for rich media. For example, licenses for rich media data may be present in a producing host. The roaming cache device may be connected to the producing host and information on the producing host may be evaluated to determine information of interest. Information determined to be of high interest to a user may be assigned a higher priority value than information of lower interest to a user. The determination if interest of data may be performed based on a number of factors including, for example, user preferences, user activities, history, etc. In one example, a producing host associated with the user may include information pertaining to an upcoming trip of the user. A determination may be made that information, including rich media, may be of interest to the user. Licenses corresponding to the data of interest (e.g., audio or video information) may be transferred from the producing host to the roaming cache device based on the determined data of interest. In addition, the licenses of the rich media information received from the producing host and stored on the roaming cache device. When connected to the consuming host, the consuming host may provide information corresponding to the stored licenses on the roaming cache device.

In another example, the predictive caching 308 module may receive proximate content information. The proximate content information includes information such as a website or other data or links associated with the information. For example, a subset of sites may be proximate or associated with one another (e.g., packed) in terms of intra-site linkages. A user may be considered to be more likely to visit websites that have an association with a website that the user does visit. Hence, based on this information, the predictive caching 308 may determine additional information to pre-cache for a user such that a user may access the additional information efficiently based on cached data from the predictive caching module 308 including proximate content. The additional information may be obtained and stored on the roaming cache device. In one example, based on user's schedule and itinerary on the producing host, cached information may be provided targeting geographic region. Further targeting may be done using past user history of travel. Any of the information may be protected to permit secure access of the information.

In another example, the predictive caching module 308 may receive special logic data from particular sites indicating methods for applying predictive caching at the particular site. As one example, certain sites such as a corporate sharepoint site, a news site, a portal associated with a homesite, to name a few, may contain logic describing an application of predictive caching to the corresponding site. The predictive caching module 308 may perform predictive caching via the indicated logic for the corresponding site, for example.

As FIG. 3 illustrates, the roaming cache device may further contain a remotely secured functional caching module 309. The remotely secured functional caching module 309 may receive information from the host device via input 301 and identify functional data associated with the host device. This functional data may be stored in the roaming cache device and may subsequently drive actions on a second host device. The functional data may include information accessed via an application other than a web browser. As one example, an application may include mail software for accessing mail information. Examples of mail software include Outlook, Outlook Express, Windows Live Mail Desktop, etc., or instant messaging software, to name a few. The information may vary in amount and may range from as little as a user's personal profile (e.g., for instant messaging software) to a full mailbox mirror (measured in gigabytes) and larger.

In addition, security of the functional data may rely on factors not contained on the storage. Depending on the application, security may also be tied to an online service and a user may secure personal data at any time by various security means online (e.g., changing a password online). In one example, a user may re-secure personal data at any time by changing a password online.

As yet another example, FIG. 3 illustrates a web caching module 310 in the roaming cache device. The web caching module 310 receives information corresponding to a host device or a user of the host device via the input 301. The web caching module 310 further determines any type of personal or portable web cache information. When the roaming cache device is connected to another host device, data may be accessed (e.g., via the internet) based on the stored personal or portable web cache information identified by the web caching module 310. Storage of the personal or portable web cache information on the roaming cache device may permit use of a local cache without permanent use of the information on the same machine.

The roaming cache device in FIG. 3 further includes a prioritizer 304 that may be controlled by the processor 303. The prioritizer 304 of the example illustrated in FIG. 3 receives data from caching module 302 which provides information and data received from a host device and identified and categorized by various modules (e.g., trustworthy caching module 307, predictive caching module 308, remotely secured functional caching 309, and/or web caching 310). The prioritizer 304 ranks cached information in order of priority of the data and/or assigns a priority factor to the data. The determination of the priority of a portion of data may be accomplished by examining the nature of the data, the amount of data, the location of the data, user information, and other features of the received and stored data based on a corresponding user.

For example, a user may be planning a business trip to a foreign country. Information pertaining to the trip including e-mails discussing the trip or containing flight information may be accessed. The information may be received from a personal computer at the roaming cache device via input 301 and may further be identified (e.g., by the remotely secured functional caching module 309). In addition, based on the information, the roaming cache device may receive or store additional data pertaining to the identified activity. In this example, the predictive caching module 308 may determine proximate content associated with the trip to the foreign country and may receive further cache information on the related information. This information may also be stored in memory 305. In yet another example, the roaming cache device may further anticipate via the predictive caching module 308 the user's desire for additional video content to view during the trip and cache additional video content for the user. This video content may further be selected based on a past history, preferences, and/or personal profile of the user, for example.

The prioritizer 304 in the example illustrated in FIG. 3 evaluates the cached data from caching module 302 of the roaming cache device and assigns a priority factor to each portion of data. The data may thus be ranked according to priority such that high priority data may be provided prior to low priority data or may otherwise be presented to the user in a manner indicating increased importance or relevance of the data. Values of priority may be assigned based on a variety of factors including, for example, by personal preferences, prior history or habits, data content on a host device, or commercial preferences, to name a few.

In addition, as FIG. 3 illustrates, the roaming cache device may further include an access module 306 for permitting access of data in the roaming cache device to a host device or for outputting data for controlling accessing data on a host device. The output data for accessing data on the host device may further be based on cache data stored in memory 305. For example, the roaming cache device may contain cache data stored in memory 305 and may further be connected to a host device. Information may be accessed or manipulated on the host device. As one example, the host device includes a publicly used computer that does not contain information specific to a user. The user may connect the roaming cache device to the publicly used computer and may further access information on the computer. For example, the user may access the internet and input information on the publicly used computer. User input may be detected at the roaming cache device. The input information may be received at input 301 and may further be compared with stored information in memory 305. As FIG. 3 further illustrates, a comparator 311 may provide data to the host device via the access module 306 based on the user input received at input 301 and data stored in memory 305.

For example, the memory 305 may contain web cache information corresponding to frequently visited website locations for the user. Based on query or other information input by a user at a host device (e.g., personal computer), the comparator 311 may provide output data via the access module 306 to the host device such that information provided to the user on the host device corresponds to the web cache data from memory 305. Alternatively, the access module 306 may permit access to the data by the host device. In one example, a user may input a search query into a web browser application on the host device. The host device may access the data stored on the roaming cache device via the access module 306 and the web browser application returns search results based on the cache data stored in memory 305 of the roaming cache device.

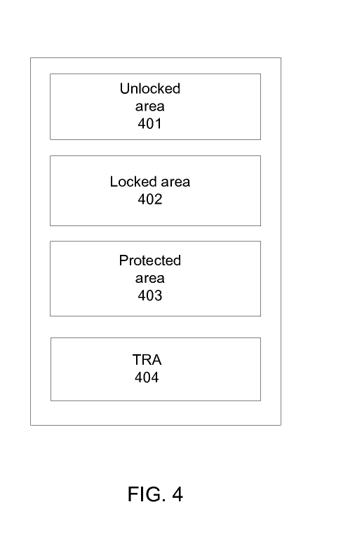

The roaming cache device may contain memory that includes any number of portions of memory. Any of the portions of memory may have any level of access or may be protected, locked, unlocked, etc. Access levels may be based on the type or nature of data stored therein. FIG. 4 illustrates one example of memory in a roaming cache device. In this example, the memory 400 contains an unlocked area 401, a locked area 402, a protected area 403 and a tamper-resistant area (TRA) 404. The illustration of FIG. 4 is merely one example and any additional memory components may be included in memory of a roaming cache device. In addition, any of the memory components illustrated in FIG. 3 may be re-configured, rearranged, combined or skipped.

The locked area 402 of memory 400 of the roaming cache device may contain secure data. This data may have limited access from host devices. For example, certain host devices may be permitted access to information in the locked area 402 while other host devices may not access the information in the locked area 402. Alternatively, data stored in the locked area 402 may be accessed by only devices that have been authenticated. Access to the locked area of memory on device 502 may be controlled by a processor on the roaming cache device. For example, a host device may be authenticated and after authentication of the host device, the host device may access data stored in the locked area 402 of memory 400 of the roaming cache device.

In addition, the memory 400 of the roaming cache device may contain a protected area in which data within the protected area may not be accessible by a host device. For example, sensitive information may be contained in the protected area 403 of memory 400 of the roaming cache device such that a host device may not access the data. A processor may manage the protected area 403 to control access to the area and/or to update information contained in the host device. Alternatively or additionally, access to the data may be granted after authentication of the roaming device from the host device. The authentication may be performed by the user, for example.

The TRA 404 area may contain critical information that may not be altered by a user. For example, TRA 404 may include identity information for devices and corresponding users. TRA 404 may further include priority information for cache data if data integrity for the priority information is desired, for example.

The memory 400 of the roaming cache device may also contain an unlocked area 401 in which host devices may access. The unlocked area 401 may contain information that may be shared and/or modified by host devices. A processor in the roaming cache device may further monitor or control access to the unlocked area, if desired. Alternatively or additionally, priority information for cache data may be stored in the unlocked area 401 if user modification of the cache information is desired, for example.

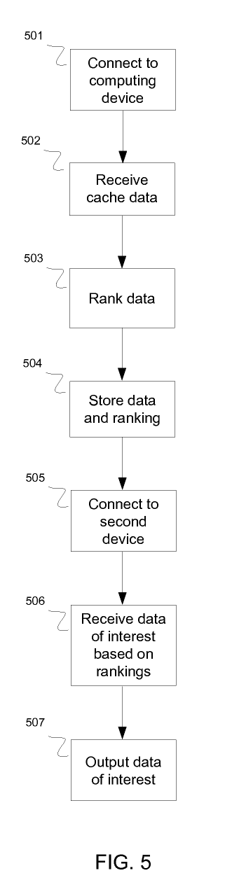

FIG. 5 is a flowchart illustrating one example of caching data on a removable device. In this example, a device such as a roaming or removable cache device may be connected to a host device (STEP 501). For example, a roaming cache device may be connected to a personal computer. The personal computer may contain user information that may be stored in memory on the roaming cache device. The information may be downloaded to the roaming cache device by the user or may be automatically transferred when the roaming cache device is connected to the personal computer. In STEP 502, the cache data is received at the roaming cache device. The information received may include any relevant user information such as a user profile, user preferences, past history, mail information, application information, etc.

The information may be stored in memory on the roaming cache device. In addition, the information may be ranked (STEP 503). For example, the information may be identified based on type, content, or relevance and may be assigned a priority value indicating the priority of the information. The priority may be assigned by a factor to indicate a relative importance of the corresponding information. If information is determined to be of high importance or relevance, a high priority factor may be assigned to the information. Conversely, if information is determined to be of low importance or relevance, a low priority factor may be assigned. The information received at the roaming cache device from the personal computer (i.e., host device) may be stored in memory of the roaming cache device with a corresponding priority factor (STEP 504).

In one example, the roaming cache device may obtain additional information from the host device based on the priorities of stored data in memory. For example, certain stored data in memory on the roaming cache device may have high corresponding priority factor values. Additional information associated with or related to the stored data may be obtained from the host device. The additional information may be received at the roaming cache device and stored in memory on the roaming cache device. Also, priority values may be assigned to the additional information.

A user may disconnect the roaming cache device from the personal computer. The roaming cache device may further be connected to a second host device (STEP 505). In one example, the second host device includes a personal computer. Additionally, the second host device may be any device capable of connecting with the roaming cache device such as a computer, a consumer electronic device (e.g., television, etc.), automobile, etc. Data cached on the roaming cache device may be prepared on a producing host to match the capabilities of the second host device. For example, the second host device may be a publicly used personal computer that may not contain user information or preferences. The user may connect the roaming cache device to the second host device (STEP 505) where the roaming cache device contains information received from the first personal computer and corresponding priority values and stored in memory on the roaming cache device.

The user may perform actions or events on the second host device. Results of the actions or events performed by the user on the second host device may be based on the data and priority information stored in memory of the roaming cache device. For example, a user may access the internet on the second host device (e.g., a second personal computer) and may further request information via the internet. The second host device may perform an action or event to obtain requested information as requested by the user. However, the information provided by the second host device may also be based on the data and priority information stored in memory of the roaming cache device. In one example, the user may perform a query on a search engine using a web browser on the second host device. The second host device provides search results via the web browser to the user corresponding to the query. The search results may further be based on web cache data, for example, from memory of the roaming cache device. In this example, the search engine returns the search results according to user information and associated priority information on the roaming cache device. Thus, the second host device may receive data of interest (based on the search query) and may further provide this information to the user in order of priorities or values of priority factors associated with the information returned (STEP 506).

The data of interest may be output to the user (STEP 507). The output may contain the results of the action (in this example, results from a search query) in a particular order. The order may be based on relevance or interest to the user which may further be determined based on information (e.g., priority information) stored in memory of the roaming cache device.

The second host device may be a computing device which may not be known to be secure. One example is a publicly used personal computer (e.g., Internet café, etc.). In this example, the user may use the computing device (e.g., publicly used computer) with the roaming cache device. The roaming cache device may provide cache information to enhance use of the publicly used computer.

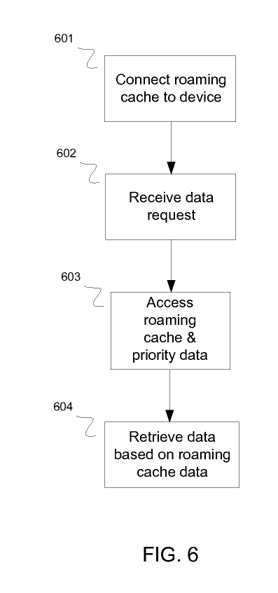

FIG. 6 is a flowchart illustrating an example of a roaming cache device and a consuming host device. In this example, the roaming cache device may be connected to the second host device such as a consuming host device (STEP 601). The connection may be accomplished via a variety of methods. In one example, the roaming cache device is connected to the second host device via a USB connection. After connecting the roaming cache device to the second host device, the second host device may receive a request from the user (STEP 602). The request may be a command for an action or event on the second host device. The action or event may include accessing data on a network such as the internet. Information may be returned (STEP 604) responsive to the request or command from the user. The information returned may further be based on data stored on the roaming cache device which may also include priority information associated with the stored information (STEP 603). For example, information associated with high priority data stored on the roaming cache device may be returned on the second host device. Information associated with lower priority data stored on the roaming cache device may also be returned on the second host device. In this example, the lower priority data may be presented in a manner indicating the lower priority of the information (e.g., later than higher priority information).

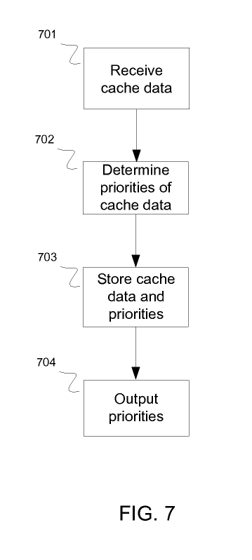

FIG. 7 is a flowchart illustrating one example of determining priority of cache information on a roaming cache device. In this example, a roaming cache device may be connected to a host device such as a personal computer. Cache information from the personal computer may be transferred to the roaming cache device and stored in memory of the roaming cache device (STEP 701). Additionally, the information received from the personal computer may be ranked and/or assigned a priority factor value to indicate priority of the information received (STEP 702). Priority factor values may be determined in a number of ways based on the data received from the personal computer or other host device. Some non-limiting examples include user profiles, prior history, location, mail information, application information, etc. The cache information may be stored in memory of the roaming cache device with associated priority factor values (STEP 703). The roaming cache device may be disconnected from the personal computer and may be connected to a second host device. Actions and events performed on the second host device may be performed based on the cache information provided by the roaming cache device and associated priority factor values. For example, results of actions or events on the second host device may be based on cache information with a high priority factor value. A user may request the action or event on the second host device. Priority factor values and information may be output from the roaming cache device (STEP 704).

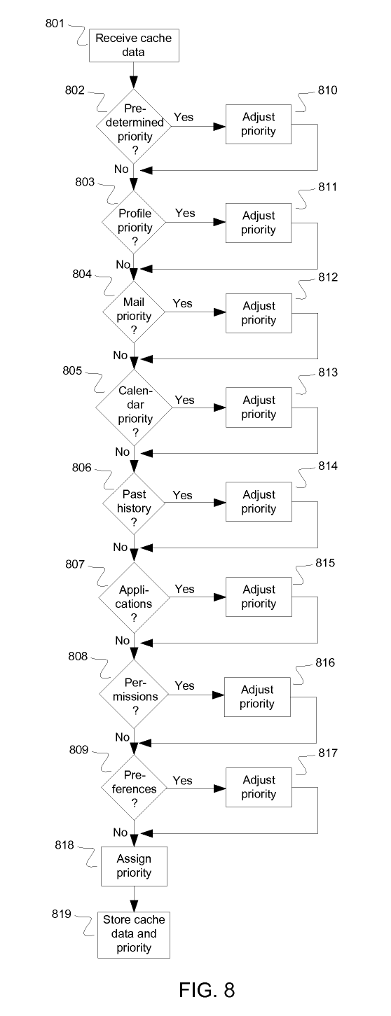

Priority of cache information may be determined in any number of ways. FIG. 8 is a flowchart illustrating non-limiting examples of priority value determination of cache information. However, additional factors may be included. In STEP 801, cache information is received by a roaming cache device. A priority factor module in the roaming cache device may determine a priority factor value for the information. In one example, the priority factor module may determine if a predetermined priority is associated with the received cache information (STEP 802). For example, the priority may be predetermined by any entity such as a user or a manufacturer of the roaming cache device. In this case, the priority of the cache information may be assigned to the cache information (STEP 810, STEP 818) and the cache data may be stored in memory of the roaming cache device with the corresponding priority value (STEP 819).

In another example, a user profile may be used to determine priority of the cache information (STEPS 803, 811). For example, a user profile may be maintained or stored in the host device (e.g., personal computer). Based on values in the user profile, a priority value may be assigned to the cache data. For example, a user profile may contain demographic information pertaining to the user such as age or areas of interest. Based on this information, the roaming cache device may determine that certain corresponding types of information are of high relevance. A high priority factor value may be assigned to the information corresponding to the demographic data in the user profile in this example (STEP 811). In another example, a user may create a user profile. For example, if a user desires information on a particular entity, location, or subject matter, the user may create a user profile indicating the interest in the desired subject matter. As one example, a user may wish to travel to a particular destination and may wish to receive information pertinent to the destination. The user profile may include an indication of an interest in the destination location such that higher priority values may be assigned to entities associated with the destination location.

In another example, priority values may be based on information in a mail application (STEPS 804, 812). For example, e-mails of a user may be used to determined areas of interest or relevant events pertaining to a user. Based on information from the e-mails of the user, corresponding cache information may be assigned a high priority value if relevant to the e-mail information. For example, a user have a mail application (e.g., Outlook) running on a host device such as a personal computer in which several e-mails are present. The e-mails may indicate that the user will engage in a particular activity. Information pertaining to the specified activity may be assigned a high priority by the roaming cache device.

In another example, a user's calendar information may be used to determine priority of cache information received from a host device (STEPS 805, 813). In this example, a user may contain a calendar application that contains calendar, meeting and/or appointment information for the user. The roaming cache device may receive information from the host device and may further detect relevant information from the user's calendar. This may include, for example, upcoming events or meetings or areas of interest for the user based on activities in the calendar. If a match is detected in this example, a high priority may be assigned to information that is pertinent to information on the user's calendar.

In another example, past history or past activities may be used to determine the priority of information received from a host device (STEPS 806, 814). In this example, past history or activities of a user may be used to determine priority values for information received from a host device. For example, a user may frequently visit certain websites and may store certain information such as cookies pertaining to favorite websites. This information may be used by the roaming cache device to determine a priority value for information associated with the prior history information of the user. In one example, the roaming cache device receives past history on visits to websites and further receives cache data to be stored in memory. If the cache data corresponds to the past history information for the user, a high priority value may be assigned to the cache data.

In another example, applications (STEPS 807, 815) may be used to determine the priority of information received from a host device. For example, certain application may be running on a host device. Based on data provided by the applications or the pattern of use of applications by the user, priority values may be assigned to corresponding data received from the host device. In one example, information associated with certain applications may be assigned a high priority.

In other examples, user permissions (STEPS 808, 816) and/or user preferences (STEPS 809, 817) may be used to determine the priority of information received from a host device. Any additional factors may be used to determine priority values for information from a host device. In addition, combinations of factors may be used to determine a priority value.

In another example, a third party may program priority information into a roaming cache device. Certain entities may be assigned a high priority by the third party and programmed into the cache device. Thus, priority information may be predetermined. Determination of priority of information by a third party may be accomplished in many ways. For example, the third party may be a manufacturer of the roaming cache device and the priorities for information may be determined on a commercial basis. Commercial entities may purchase a desired priority value. In one example, a user may perform a search query on a host device. The stored cache data on the roaming cache device may include web cache data that may determine an order of search results based on the search query. A commercial entity may have purchased a desired priority value such that the search results may contain a listing of the commercial entity in a position on the search results based on the desired priority value.

As one example to illustrate, a user may be leaving to a foreign country and may be conducting activities in the foreign country. The user may wish to obtain information on the foreign country and may also wish to take certain information along to use in the foreign country. The user in this example connects a roaming cache device to the home computer. Information from the home computer is downloaded to the roaming cache device which may include, for example, e-mails, executables, or cookies, to name a few. Downloading may be performed automatically or manually. Web cache information may also be stored in memory on the roaming cache device such that web browsing at the destination location (i.e., foreign country) may be expedited. Additional information predicted to be of interest to the user may also be stored in memory on the roaming cache device. In one example, information is predicted to be of interest to the user based on priority values associated with stored information on the device.

The information downloaded to the roaming cache device may be ranked. Information from various sources may be included on the roaming cache device, for example. Each of the information components may be assigned a priority value and ranked in order of priority. The information may be stored in memory on the roaming cache device with the corresponding priority value. The priority values may be based on a variety of factors including, but not limited to, user preferences, profile data, prior history, commercial preferences, e-mail data, location, etc. The stored information and priority data may further be used at a remote computer for obtaining desired information in a secure manner at the remote computer.

The user may then disconnect the roaming cache device from the home computer and may travel to the foreign country. While in the foreign country, the user may access any remote computer, including publicly used computers (e.g., Internet café computers). The user may connect the roaming cache device to the remote computer such that cache information stored on the roaming cache device may be utilized on the remote computer. Also, the data on the roaming cache device is trusted and secure data. For example, the data may not be stored on the remote computer so that the user may not leave information on the remote computer after use.

Actions or events may be performed on the remote computer which may be based on the data stored on the roaming cache device. For example, the user may perform a search query on the remote computer. Results of the search may be provided on the remote computer in which the search results may be based on web cache data and corresponding priority data stored on the roaming cache device. In one example, information stored in memory on the roaming cache device may include a user profile or user preferences indicating an interest in a particular subject matter. Also, the information may include web cache data indicating websites that the user has visited previously. The priority values of information may be high for information associated with the subject matter of interest based on, for example, the nature and frequency of access of information related to the subject matter. For example, a high priority value may be assigned for information on a particular subject matter if the user profile, user preferences and web cache data stored on the roaming cache device indicate that the subject matter is of interest to the user. However, a lower priority value may be assigned if the subject matter is not of interest to the user based on the stored information on the roaming cache device. In another example, a high priority may be predetermined based on commercial preferences. In this example, the priority value may be predetermined in the roaming cache device.

The user in this example may further connect the roaming cache device to any device capable of providing desired information. For example, the user may connect the roaming cache device to a television to access the internet. The roaming cache device contains cache information such that the television may act as a cross-platform device for accessing the internet. The television, as connected to the roaming cache device, may further provide any desired information or advertisements, for example. The advertisements may be overlaid on the image (e.g., cache content), for example. Preferences, policies, etc. may be automatically obtained on the host device (e.g., remote computer, television, etc.) from the remote cache device, which further maintains security of the data.

In another example, a feedback loop may exists between the roaming cache device and a host device. In this example, the roaming cache device may store information from a first host device (e.g., a producing host device) and may be transported to a remote host device (e.g., a consuming host device). The remote host device accesses information based on the stored information on the roaming cache device. The user's habits may be recorded in an audit file at the remote host device such that activities and events performed by the user at the remote host device may determine modifications to the cache data on the first host device (e.g., producing host device). When the user returns to the first host device, the user connects the roaming cache device to the first host device and the user's activities and events performed at the remote host device (e.g., consuming host device) may be provided to the first host device. The cache information and/or associated priority values in the first host device may be modified based on the activities or events performed at the remote host device. For example, if a user does not access information pertaining to a particular subject matter but the particular subject matter has a high priority, the priority of the subject matter may be adjusted accordingly (i.e., reduced).

It is understood that aspects of the present invention can take many forms and embodiments. The embodiments shown herein are intended to illustrate rather than to limit the invention, it being appreciated that variations may be made without departing from the spirit of the scope of the invention. Although illustrative embodiments of the invention have been shown and described, a wide range of modification, change and substitution is intended in the foregoing disclosure and in some instances some features of the present invention may be employed without a corresponding use of the other features. Accordingly, it is appropriate that the appended claims be construed broadly and in a manner consistent with the scope of the invention.

1. A method for operating in a computing system, the method comprising:
receiving data from a first host device;
prioritizing the received data;
storing the prioritized data;
connecting to a second host device; and
providing the prioritized data from the first host device to the second host device based on the prioritized data,
wherein an action is performed on the second host device based on the prioritized data from the first host device.

2. The method of claim 1 wherein the providing step comprises:
receiving a request from the second host device for access to the prioritized data;
permitting access to the prioritized data responsive to the request.

3. The method of claim 2 further comprising disconnecting from the second host device, wherein prioritized data is not stored on the second host device after disconnecting.

2. The method of claim 1 wherein the step of prioritizing the data includes determining a priority factor value for the received data and the step of storing includes storing the received data and the priority factor value corresponding to the received data from the first host device.

3. The method of claim 2 wherein the action is further performed on the second host device based on the priority factor value for the prioritized data.

4. The method of claim 3 wherein the step of providing the prioritized data includes authenticating the second host device.

5. The method of claim 4 wherein the step of providing further includes permitting access to the prioritized data by the second host device based on the authenticating.

6. The method of claim 1 wherein the providing step comprises;
authenticating a third host device, the third host device connected to the second host device;
determining an untrusted status of the second host device based on the prioritized data; and
providing the prioritized data to the third host device via the second host device based on the connection with the second host device.

7. The method of claim 1 wherein the action includes executing a search query, and wherein the second host device displays a list of search results responsive to the search query and based on the prioritized data.

8. The method of claim 1 wherein the prioritized data includes trustworthy cache data, the trustworthy cache data including an executable control.

9. The method of claim 1 wherein the data includes predictive cache data, the predictive cache data including one of serialized content, rich media content, proximate content, or special logic.

10. The method of claim 1 wherein the data includes remotely secured functional cache data, the remotely secured functional cache data including one of mail software or instant messaging software.

11. The method of claim 1 wherein the storing includes storing the prioritized data in a portion of memory separate from the second host device, the second host device having access to the portion of memory.

12. The method of claim 11 wherein the action is performed by the second host device based on the prioritized data stored in the portion of memory.

13. A method for operating in a computing system, the method comprising:
receiving prioritized data from a first host device;
storing the prioritized data;
connecting to a second host device; and
providing the prioritized data from the first host device to the second host device,
wherein an action is performed on the second host device based on the data from the first host device.

14. The method of claim 13 wherein the prioritized data is prioritized on the first host device.

15. The method of claim 14 wherein the prioritized data is prioritized on the first host device based on a user profile, the user profile being stored on the first host device.

16. The method of claim 14 wherein the step of receiving prioritized data further includes receiving additional data based on the prioritized data, the additional data including user preferences, web cache data, a user profile, permissions, applications, browsing history, past action history, mail data, proximate content associated with a website, video data, audio data, serialized content, an executable control, or cookies.

17. The device of claim 14 wherein the second host device is connected to a third host device, the device providing access to the prioritized data to the third host device, the prioritized data being non-accessible to the second host device.

18. The method of claim 14 wherein the providing step includes permitting the second host device to access the prioritized data.

19. The method of claim 18 wherein the storing step includes storing the prioritized data in a first portion of memory of a plurality of portions of memory, the second host device having access to the first portion of memory and not having access to a second portion of memory of the plurality of portions of memory.

20. A removable roaming cache device comprising:
a connector for connecting to one of a first host device or a second host device;
a caching module for receiving cache data from the first host device;
a prioritizer for determining a priority factor value for the cache data;
memory for storing the cache data and the corresponding priority factor value;
an access module for permitting access to the cache data by the second host device.
